(19) United States
(12) Patent Application Publication
(10) Pub. No.: US 2004/0174536 A1
(43) Pub. Date: Sep. 9, 2004

(54) Device for characterising optical gratings and method for making optical gratings with predefined spatial frequency

(76) Inventors: Yves Jourlin, Saint-Etienne (FR); Olivier Parriaux, Saint-Etienne (FR); Marc Andre Pierre Bonis, Compiegne (FR)

Correspondence Address: SUGHRUE MION, PLLC, 2100 PENNSYLVANIA AVENUE, N.W., SUITE 800, WASHINGTON, DC, 20037, US

(21) Appl. No.: 10/479,045

(22) PCT Filed: May 22, 2002
(86) PCT No.: PCT/EP02/05712

(30) Foreign Application Priority Data
May 28, 2001 (FR) 0106917

(51) Int. Cl. G01B 9/02

(52) U.S. Cl. 356/521; 356/499

(57) ABSTRACT

The invention relates to an optical device (2) for characterising a diffraction grating (14) which is formed by first and second interferometric diffractive sensors (4, 6) which are integral, spaced apart from each other at a determined first distance, and each comprise a reading grating (10a, 10b) and at least one light intensity detector, these first and second sensors providing respectively first and second electrical signals which, during a relative displacement (Δx) between the device and the diffraction grating, vary as a function of the spatial frequency of this grating in first and second regions of the latter, which regions are located respectively opposite two reading gratings and each receive light supplied by at least one light source. In particular, the first and second electrical signals define first and second phases of the first and second sensors. Furthermore, the device comprises means for measuring a difference between the phases of the first and second signals and means (24) for measuring the accumulation of this difference during a displacement of the device along the grating. The invention also relates to optical devices for determining the spatial frequency of a grating of a type similar to the above-mentioned device. The invention likewise relates to methods of producing diffraction gratings using a device of the above-mentioned type.

The invention relates to an optical device for characterising diffraction gratings and a method of producing such gratings with a predefined spatial frequency. In particular, the characterisation relates to the spatial coherence of light diffraction gratings and the regularity or the precision in the production of such gratings.

The device of the invention is provided in particular as a control or test device for produced diffraction gratings or as a functional unit of a production system for diffraction gratings in which this unit ensures control of the writing means of these gratings in order to adjust precisely their spatial frequency.

Techniques for measuring the deformation of a grating are known, which form the input of the interferogram produced by a grating illuminated by two light sources, such as proposed in particular by M. Kujawinska and L. Salbut of the technological university of Warsaw in Poland. It is generally intended to stick the grating to be characterised on a flat surface subjected to deformations.

The interferogram is produced by two orders of diffraction being propagated substantially in the same direction and which are projected on a detector matrix. This technique has several disadvantages, in particular it necessitates an optical image formation which is vulnerable to vibrations and generally has optical aberrations. Then, the detection being effected by detector or CCD matrices, the dimensions of these detectors are defined in a very precise manner only with difficulty and are in particular sensitive to temperature. Furthermore, the interferogram depends upon the distance to the grating. Finally, it will be noted that this technique only measures the spatial frequency of a diffraction grating in an indirect manner. Concerning the measuring techniques, see in particular the article by the two above-mentioned authors, entitled “Grating interferometer for local in-plane displacement/strain field analyses”, PROC. SPIE. 3407, pp. 490-494, 1998.

Subsequently, in principle two methods for producing diffraction gratings will be noted. The first method considered utilises a technology which is peculiar to microelectronics, in which a “step and repeat” camera is used which serves for a photolithographic method in which a mask defining a grating or a grating field is projected on a substrate via an optical system. This method has at least two disadvantages. Firstly, shifts between a plurality of fields forming the same grating can occur. Secondly, the optical system for projecting an image of the mask onto a photosensitive layer which is disposed on the surface of a substrate where the grating is formed, is characterised by optical aberrations so that the image which is projected and defines the produced grating has deformations relative to the grating defined by the mask itself.

The second method of producing a grating is a method using means for forming continuously or linearly a diffraction grating on a substrate. There is understood by continuous formation of the grating the fact that said substrate is subjected to a continuous or quasi-continuous displacement relative to the means for forming the grating, i.e. relative to the provided writing means. This second method has certain disadvantages connected in particular with the difficulty of ensuring running of the substrate at a constant speed relative to the writing means. Variations in this displacement speed result in variations of the spatial frequency relative to the predefined spatial frequency for the grating being formed.

With respect to the first method for producing gratings, there are known various methods for measuring the aberrations of the lens system of a “step and repeat” camera, in particular described or mentioned in the documents U.S. Pat. No. 6,130,747; U.S. Pat. No. 6,091,486; U.S. Pat. No. 5,767,959. These documents utilise gratings placed in the image field of the mask defining the object grating and compare the projection of the object grating with the grating placed in the image field. In particular, the document U.S. Pat. No. 5,767,959 uses a moiré effect between two slightly different period gratings, read by a detector matrix. This last document mentions a resolution concerning the distortion of the image of the grating of approximately 1 nm. These techniques are therefore of a limited resolution and do not effect a test on the produced object itself.

The requirements concerning the distortion increase with the reduction in characteristic dimensions in microelectronics and likewise in other fields such as that of diffraction optics where the spatial frequency of patterns or periodic gratings must be controlled with a resolution greater than prior art currently allows. For example, it is known by the person skilled in the art that diffraction gratings intended for compression of laser temporal pulses must have very good spatial coherence corresponding to approximately λ/20, where λ is the wavelength used. This is manifested by a requirement for the surface evenness of the grating substrate and likewise for the regularity of the period of this grating. For example, a nominal period diffraction grating Λ₀=1 μm and having a length of 20 mm with a wavelength Λ=1 μm must not have a period deviation greater than 0.05 Angström between the first and the last period with the hypothesis of a monotone variation of the period over the length of the grating. It is thus confirmed that certain applications require being able to control the spatial variation of a grating with a resolution which is at least 100 times greater than the current measuring resolution of this variation.

By way of supplementary example concerning the necessity for having devices for characterising high resolution gratings which allow the implementation of very precise production methods, there will be mentioned Bragg gratings on fibre optics produced by means of double period phase gratings, slightly greater than 1 μm for WDM applications for optical telecommunications. These phase gratings have a typical length of a few centimetres, along which the control of the spatial coherence is essential for the wavelength and optical phase response. The effect of the aberrations of a system of lenses used in the production method or an insufficient control of the displacement of a grating band or of a fibre optic relative to the writing means in the case of a continuous production method allow gratings which satisfy the specifications of such applications to be obtained only with difficulty.

With respect to the second method of producing gratings mentioned above, techniques are known where the introduction of a band or a fibre optic into an interference field, produced by two interfering beams or by a phase mask, modulated in intensity to a frequency Ω is controlled by the instantaneous speed of the band or of the fibre, as in the document U.S. Pat. No. 5,912,999. This technique allows a relatively low precision to be obtained. Likewise there is known from the document U.S. Pat. No. 5,822,479 a technique where the continuously produced grating is read downstream of the writing means by an optical displacement sensor which controls the illumination, the latter being modulated in amplitude to a frequency Ω as a function of a control signal provided by the optical sensor. This technique allows better control of the regularity of the produced grating but does not prevent shift of the period. In fact, if the period shifts, for example because of slipping of the band or of the fibre during its introduction, the sensor only perceives this when the error is already too great.

The current necessity for providing devices for characterising optical gratings which permit very small period variations to be detected is therefore confirmed. Moreover, the evolution of the technology likewise requires providing production methods for optical gratings which have a very good spatial coherence, i.e. having a spatial frequency corresponding very precisely to the predefined spatial frequency distribution.

One object of the invention is therefore to provide a device for characterising diffraction gratings which allows very small variations in their spatial frequency to be detected.

Another object of the invention is to provide a device which allows very precise determination of the spatial frequency of a grating.

Another object of the invention is to propose methods for producing diffraction gratings which allow gratings with a very precisely defined spatial frequency to be obtained.

To this end, the invention relates primarily to an optical device for characterising diffraction gratings, this device being formed by first and second interferometric diffractive sensors which are integral, spaced apart from each other at a determined distance and each comprising a reading grating and at least one light intensity detector, these first and second sensors providing respectively first and second electrical signals which are a function of the spatial frequency of said diffraction grating in first and second regions of this grating, which are not merged, during a relative displacement of the device with respect to said diffraction grating.

In particular, the first and second electrical signals must serve for measuring respectively first and second respectively instantaneous or accumulated phases by the first and second sensors during a displacement of the device along the test grating according to a direction which is not parallel to its lines. In a preferred embodiment, the device comprises furthermore means for measuring the difference between the first and second accumulated phases, or for accumulating the difference of the first and second instantaneous phases, this measurement providing an indication relating to the variation of the spatial frequency of the diffraction grating between the two measuring regions of the two sensors and allowing determination of a variation of said accumulated phases as a function of said displacements.

The device according to the invention described above allows very precise determination of the variations of the spatial frequency of a diffraction grating.

The subject of the invention is also an optical device for determining the spatial frequency of a diffraction grating, as defined in the annexed claim 2, particular characteristics being given in the claims dependent upon this claim 2.

The subject of the invention is likewise a method of producing optical gratings by means of a photolithographic method, as defined in the annexed claim 9.

Finally, yet another subject of the invention is another method of producing diffraction gratings by means of means for continuous formation of a grating, as defined in the annexed claim 10.

The present invention will be described in more detail hereafter by means of the annexed drawings, given by way of example and in no way limiting, in which:

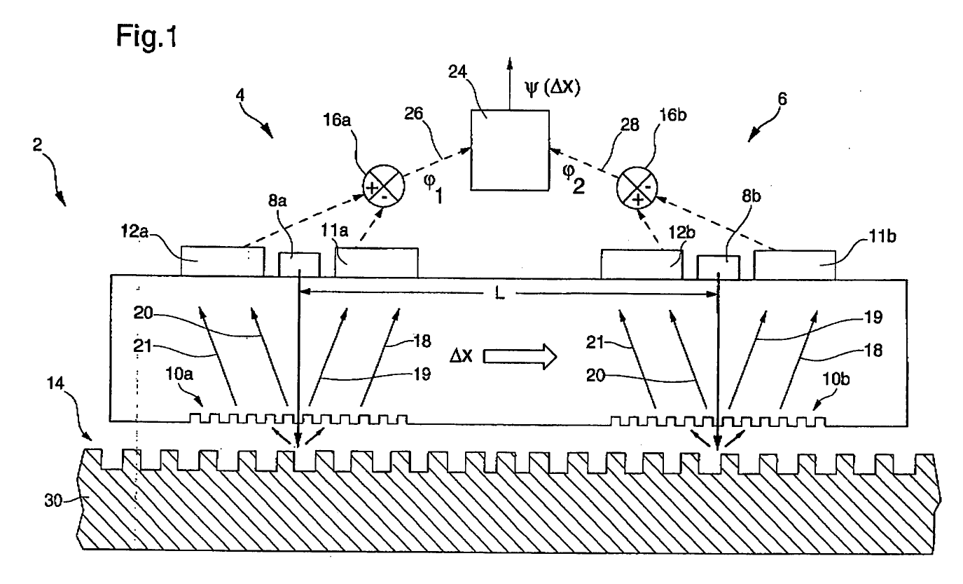

FIG. 1 represents schematically a device for characterising diffraction gratings according to the invention;

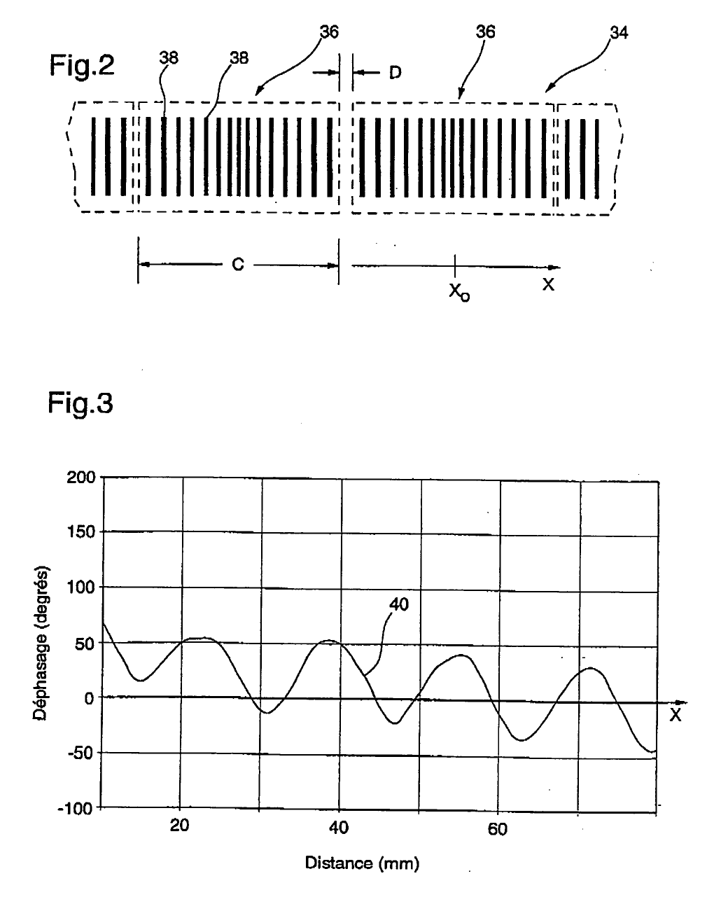

FIG. 2 represents a diffraction grating produced by means of a conventional “step and repeat” camera;

FIG. 3 represents a dephased signal obtained by the device of FIG. 1 during a displacement along the grating of FIG. 2;

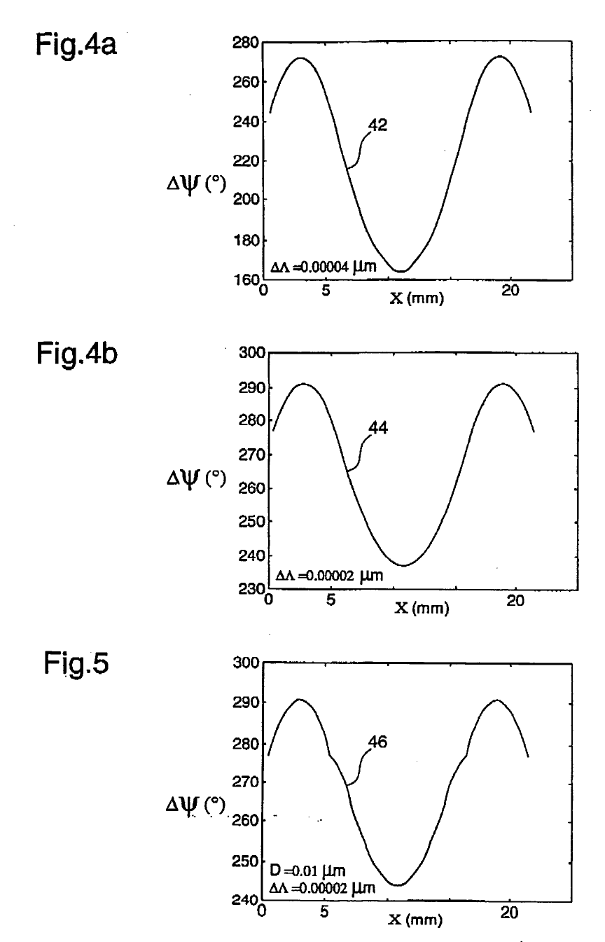

FIGS. 4a and 4b represent theoretical phase displacements obtained by the device of FIG. 1 respectively for two maximum variation values of a grating of the type represented in FIG. 2, during a displacement of this device along the grating;

FIG. 5 represents the theoretical curve provided by the device of FIG. 1 for a grating of the type of FIG. 2, showing shifts in the projection of the succession of the grating fields;

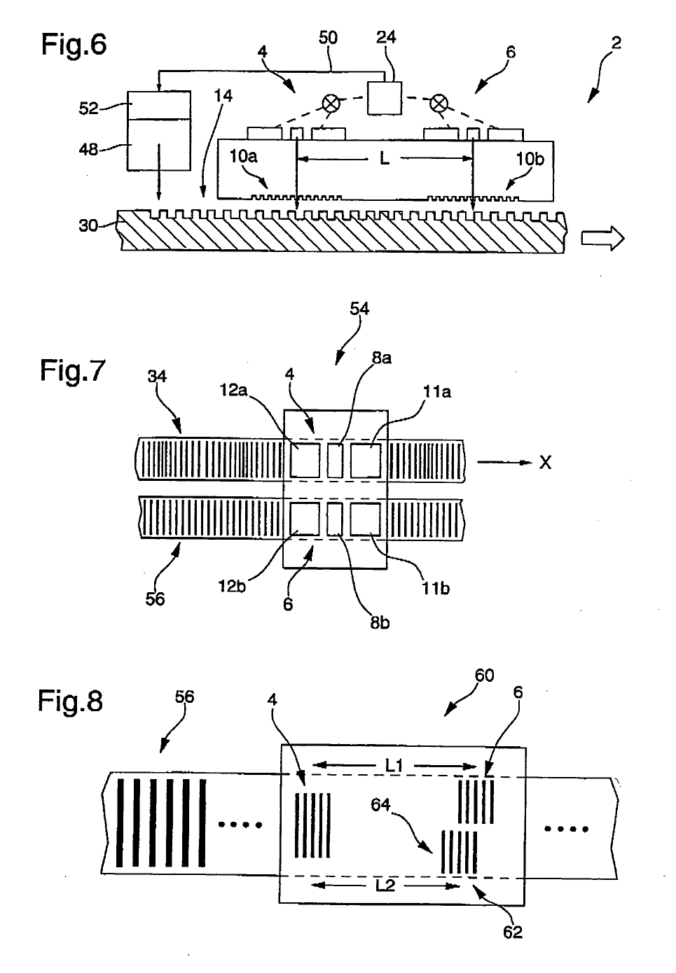

FIG. 6 represents schematically a method of continuous production of a diffraction grating;

FIG. 7 represents schematically a device for determining the spatial frequency of a grating of a type related to the device of FIG. 1; and

FIG. 8 represents another device for determining the spatial frequency of a grating likewise of a type related to the device of FIG. 1.

By means of FIG. 1, there will be described hereafter a preferred embodiment of a characterisation device according to the invention. This device is based on the known principle of interferometric diffractive coders. This device 2 comprises two interferometric diffractive sensors 4 and 6, each formed by a light source 8a, 8b, by a reading grating 10a, 10b and by two light intensity detectors 11a, 12a, 11b, 12b. The electrical signals provided by the detectors 11a, 12a, respectively 11b, 12b are provided to a subtracter which eliminates the DC component of the electrical signal resulting from the light intensity variation received by each sensor.

It will be noted that each of the sensors 4 and 6 corresponds substantially to a displacement coder described in the document EP 0 741 282 which is included in the present application by way of reference. This type of sensor requires that the spatial frequency of the reading grating 10a, 10b is approximately equal to twice the spatial frequency of the diffraction grating 14 to be characterised. Subsequently, during a relative displacement between the device 2 and the grating 14, the two detectors of each sensor provide electrical signals varying in a sinusoidal manner with a phase displacement of approximately π, for which reason the subtracters 16a, 16b allow the removal of the continuous DC component of the electrical signal provided by the detectors in response to the light intensity which is provided to them by the interfering beams 18 and 19, respectively 20 and 21.

It will be noted here that the device described in the document EP 0 741 282 shows in its Figures a displacement sensor in which the light is diffracted during transmission by the reading grating and the measuring grating. However, the person skilled in the art will readily understand that the measuring principle described in this document is likewise applied during diffraction by reflection by one or other of these two gratings, as is the case for the grating 14 for the device represented in FIG. 1. It will be noted likewise that each sensor 4, 6 can likewise comprise a second reading grating translated by a period fraction relative to the first reading grating represented in FIG. 1. This can allow the precision of the characterisation of the grating 14 to be increased more and to be useful for other measurements, in particular for the non-ambiguous measurement of the phase for a relative position given between the device 2 and the grating 14.

The sensors 4 and 6 are integral with each other and spaced apart at a determined distance L. Preferably, the reading gratings 10a, 10b are provided on the same monolithic substrate which has a very low thermal expansion coefficient, such as silicon or Zerodur. The collimated incident beams originating from light sources 8a and 8b are substantially parallel.

A phasemeter 24 measures the phase difference between the alternative signals 26 and 28 provided respectively by the sensors 4 and 6, the variation of these signals resulting from the variation of the light intensity received by the detectors during a relative movement between the device 2 and the tested grating 14 provided on the substrate 30. In another embodiment of the device according to the invention, it is provided to use two displacement sensors of the type described in particular in the document EP 0 590 163. This embodiment will not be described in more detail here, given that the person skilled in the art will know how to use the teaching of the embodiment of FIG. 1 in order to accomplish it.

According to the invention, the two electrical signals 26 and 28 are a function, during a relative displacement between the device 2 and the grating 14, of the spatial frequency of the grating 14 in first and second regions of the latter which are located respectively opposite two reading gratings and each receive the light provided by at least one light source.

The longitudinal dependence according to the x axis of the spatial frequency of the grating 14 is defined by K(x)=2π/Λ(x) where Λ(x) is the spatial period at the point x of this grating 14. It will be noted that Λ(x) corresponds in fact to the mean period over a small distance corresponding to a measuring region of the first sensor, respectively second sensor of the device according to the invention.

If φ₁(x) and φ₂(x) are the respective phases of the periodic electrical signals supplied respectively by the first and second sensors 4 and 6 to the phasemeter 24, the phase accumulated by each of the two sensors during a displacement Δx between x₁ and x₂ of the device 2 relative to the grating 14 is defined by Φ(Δx), respectively Φ₂(Δx) which are written:

$$\begin{matrix}{Φ}_{1} ( Δ x ) = 2 {\int }_{x1}^{x2} K ( y ) ⅆ y + Φ ( x1 ) & ( 1 ) \\ {Φ}_{2} ( Δ x ) = 2 {\int }_{L + x1}^{L + x2} K ( y ) ⅆ y + Φ ( L + {x}_{1} ) & ( 2 )\end{matrix}$$

Thus, the difference of the phases accumulated between the two sensors 6 and 4 is written:

Ψ(Δx)=Φ₂(Δx)−Φ₁(Δx) (3)

By taking x₁ as the origin and x₂ as variable x, one therefore has

$$Ψ ( x ) = 2 {\int }_{0}^{x} [ K ( y + L ) - K ( y ) ] ⅆ y + {Ψ}_{0} \qquad ( 4 )$$

where

$${Ψ}_{0} = Φ ( L ) = 2 {\int }_{0}^{L} K ( y ) ⅆ y \qquad ( 5 )$$

Thus, by differentiating Ψ(x) there is obtained

$$\frac{ⅆ Ψ ( x )}{ⅆ x} = 2 [ K ( x + L ) - K ( x ) ] \qquad ( 6 )$$

It can therefore be seen that the derivative of the difference of the phases accumulated from an origin position Ψ(x) gives exactly twice the difference of the spatial frequencies K(x) measured at the points x+L and x. L is defined as the distance between the centres of the two reading gratings 10a and 10b.

Starting from the fact that K(x) varies slightly around a value K₀=2π/Λ₀, Λ₀ being twice the period of the reading gratings 10a and 10b in the embodiment described in the document EP 0 741 282, a necessary condition for obtaining an interference contrast adequate to permit a measurement, one has

Λ(x)=Λ₀+ΔΛ(x) with |ΔΛ(x)/Λ₀|<<1 (7)

With this hypothesis, there is obtained

$$\begin{matrix}\frac{ⅆ Ψ ( x )}{ⅆ x} ≅ \frac{4 π}{{Λ}_{0}^{2}} [ ΔΛ ( x ) - Δ Λ ( x + L ) ] & ( 8 ) \\ \frac{ⅆ Ψ ( x )}{ⅆ x} ≅ - \frac{4 π}{{Λ}_{0}^{2}} [ Λ ( x + L ) - Λ ( x ) ] & ( 9 )\end{matrix}$$

Generally, starting from the hypothesis that the variation of the period of the tested grating is defined by a function F(x), one can formulate

Λ(x)=Λ₀+ΔΛₘf(x) with |f(x)|<=1 (10)

where ΔΛₘ is the maximum variation of the period relative to Λ₀.

There is thus obtained

$$Ψ ( x ) ≅ \frac{{K}_{0}^{2} {ΔΛ}_{m}}{π} {\int }_{0}^{x} [ f ( y ) - f ( y + L ) ] ⅆ y + {Ψ}_{0} \qquad ( 11 )$$

If f(x) is known, it is possible by integrating it to determine directly ΔΛₘ of the measured graph Ψ(x), in particular by “curve fitting”.

If the integration of f(x) presents a problem, the obtained graph of Ψ(x) can also be differentiated.

It will be noted that, as defined, Ψ(x) is equal to 4π times the number of periods of the grating 14 between two measuring points x+L and x. Experimentally, the device according to the invention measures Ψ(x)−Ψ₀, the constant Ψ₀ being able to be determined by a preliminary measurement. In any case, in the differential equation (6) given earlier, the constant Ψ₀ disappears. This device thus measures twice the variation of the number of periods of the tested grating over a fixed distance L between an initial position and any other position x of the device relative to this grating by a displacement of this device between these two positions.

The phasemeter 24 comprises means for measuring a difference between the phases φ₁ and φ₂ of said first and second signals and also means for measuring the accumulation of this difference during a displacement Δx of the device relative to the grating 14 according to a direction which is not parallel to its lines. In another variant, the phasemeter 24 comprises means for accumulating the phases φ₁ and φ₂ and means for effecting the difference of these two accumulated phases.

In order to allow the analysis or the effecting in particular of the derivative of the graph Ψ(x), the device according to the invention comprises preferably means for storing the above-mentioned difference and/or a function of the latter as a function of the displacement between the grating 14 and the device 2. In order to analyse and/or process the above-mentioned difference as a function of the relative position between the device 2 and the grating 14 or as a function of a relative displacement between the latter as described above, the device according to the invention comprises or is associated with means for analysing and/or processing the signal Ψ(x) provided by the phasemeter 24 to almost a constant.

A general method for resolving the equation (6) comprises using the Fourier transform known to the person skilled in the art. The Fourier transform of K(x) can be expressed explicitly in terms of the measured Fourier transform of Ψ(x) and of known coefficients. The function K(x) is therefore found by an inverse Fourier transform. Other methods for resolving this equation (6) likewise exist, in particular by means of computer programmes allowing adjustment of a function to an obtained experimental curve, in particular the curve. Ψ(x) or its derivative. These general methods allow in particular the shifts or “stitching errors” between the fields projected by a “step and repeat” camera to be taken easily into consideration.

In the case where K(x) is a substantially periodic function, as is the case in particular when a grating is produced by a “step and repeat” process, the resolution of the equation (6) can be processed by a development in a Fourier series of right and left members of equality.

One of the production methods for diffraction gratings comprises using a “step and repeat” camera which projects the image of an object grating defined by a mask onto a photosensitive layer deposited on the surface of a substrate. For gratings of a certain length, the camera projects a portion of the grating, named subsequently a field of the grating, then effects a displacement before again illuminating the photosensitive layer in order to form a field adjacent to the field previously formed. Thus there are obtained gratings of a certain length formed by a succession of fields within which there is located a portion of the image grating of the projected mask. As mentioned in the preamble to the present description, the “step and repeat” cameras comprise a system of lenses which has aberrations and in particular spherical aberrations. The latter engender a variation of the period of the grating according to a substantially parabolic longitudinal direction for a mask defining a constant period grating. The grating thus obtained is represented schematically in FIG. 2.

The distribution of the variation of the period of the grating 34 can be expressed by the formula (10), given earlier, in which f(x) is given by the following analytical function:

$$f ( x ) = {( \frac{x - {x}_{0}}{C / 2} )}^{2} \qquad ( 12 )$$

The constant C corresponds substantially to the length of the field 36. Supposing for example that the period Λ₀=1 μm and the length of a projected field is equal to 16 mm, the distribution of Λ over a field given by the formulae (10) and (12), such an aberration can lead to a error in the displacement measurement at the edge of each field by a value of around 50 nm over the 8 mm of displacement from the middle position x₀ of this field for a camera which has an optical system of normal quality. Thus, for a grating formed by N fields, the use of such a grating in a displacement coder leads to a measurement error of 0.1N μm, which is not acceptable for a plurality of applications. It will be noted that the grating represented in FIG. 2 is simplified by the fact that it represents in effect the effect of spherical aberrations only in a longitudinal plane of this grating. In effect, because of spherical aberrations, the lines 38 of the grating are slightly inwardly curved. Other types of aberrations are furthermore present which cannot be represented by the function f(x) given as an example by the formula (12). These two characteristics will therefore be required to be taken into account in the production method which will be described hereafter.

For a grating similar to the diffraction grating 34, Ψ(x) supplied by the device 2 corresponds to the graph 40, as is represented in FIG. 3. It is noted that the curve 40 has a behaviour which is of a substantially sinusoidal type. In FIGS. 4a and 4b, there are represented the theoretical curves 42 and 44 for Ψ(x) with the hypothesis of the parabolic distribution of the period variation given by formula (12). The curves 42 and 44 correspond respectively to ΔΛm=0.4 Å, 0.2 Å. It will be noted that in the present case Λ₀ corresponds to the minimum period located in the centre of the field. Taking Λ₀ as the mean value between the two extreme values of the field, there is therefore obtained a variation over Λ corresponding to half of the values mentioned in FIGS. 4a and 4b. The maximum variation of the period over a field is directly proportional to the measured amplitude difference on the graph of Ψ (curve 40). It will be noted that the drift of the curve 40 and of FIG. 3 towards negative values when x increases originates from the fact that the distance between the tested grating and the device according to the invention varies as a function of the displacement and that the two incident collimated beams in the two sensors 4 and 6 are not strictly parallel.

As a resolution over Ψ(x) of the order of one degree can be obtained readily, it is possible to envisage detection of variations over the period of a grating of the order of a hundredth of an Angström. This demonstrates to what point the characterisation device according to the invention and the production process of the grating which is associated thereto are resolvent.

It will be noted also that the curve 40 obtained by the device of the invention has in certain positions slight bumps or hollows. The latter are due in particular to recording errors from the adjacent fields originating from positioning errors of the table, on which the produced substrate of the grating is placed. In FIG. 5 there is represented the obtained theoretical curve 46 of Ψ(x) for a parabolic distribution with the same maximum variation of the period as in FIG. 4b, but with a shift D=0.01 μm between two fields 36 (see FIG. 2), above which the device of FIG. 1 passes.

According to the invention there is provided a first method for producing optical gratings by means of a photolithographic method, using in particular a camera of the “step and repeat” type, in which a mask, defining an object grating, is projected onto a substrate via an optical system which has aberrations. This method is characterised by the following method steps:

a preliminary step in which a first mask, defining a reference grating with a precisely determined spatial frequency distribution, is projected onto a test substrate;

a step for characterising a first test grating formed on the test substrate during the preliminary step by means of an optical device according to the invention, the characterisation allowing definition of the distribution of the period of the test grating at a very high resolution, in particular according to the method explained above in the case of spherical aberrations;

the production of a second predistorted mask as a function of the characterisation of the first test grating so as to compensate for the aberrations;

the production of optical gratings on one or more substrate(s) with the use of the second predistorted mask so that these gratings have a precisely predefined spatial frequency.

Given the very great precision in the determination of the spatial coherence and in particular of the spatial frequency of the test grating by the device according to the invention, it is therefore possible for the person skilled in the art, by analytical means or with the help of specific computer programmes which are known to him, to define the spatial distribution of the working grating defined by the predistorted mask with the same precision in order to obtain the image field of this predistorted mask, a grating presenting perfectly the predefined spatial frequency distribution. The only limitation for the precision of producing the predistorted working mask results from the writing resolution of the grating modified by this mask. On this subject it will be mentioned that the evolution of systems for writing or forming such gratings in a mask allows control of the position of the writing beam in a manner which is always more precise. Such is the case in particular for the new generation of the Leica system allowing control of the writing position at 0.05 nanometres (see DE 10011202.1) It being given that the object grating defined by the mask is projected in the image plane with a reduction of approximately a factor 5, the resolution of the spatial period of the produced diffraction grating is approximately 0.1 Å. An example is given hereafter of the correction which is currently possible with the available “step and repeat” cameras in microelectronics foundries.

After the longitudinal dependence K(x) or Λ(x) has been determined, the predistorted mask correcting the aberrations can be produced. For example, in the case of a grating produced by a “step and repeat” camera, the effect of the aberrations is to give, from a strictly periodic grating, an aberrant image where the longitudinal dependence is measured in a photorepeated field for example as

Λ(x)=Λ₀+ΔΛₘ((x−x₀)/(C/2))²

The corrected mask, the projection of which will give a grating of a constant period, will have a longitudinal dependence of the period given by

Λ′(x′)=Λ₀′−ΔΛₘ′((x′−x₀′)/(C′/2))²

where Λ′, Λ₀′, ΔΛₘ′, C′, x₀′ and x′ are the geometric parameters of the corrected grating in the plane of the mask, these parameters being those of the aberrant grating multiplied by an enlargement factor M which is, in the normal “steppers”, a factor of 4 or 5. The measured parabolic dependence of Λ(x) gives a typical value of ΔΛₘ of 0.02 nm, therefore ΔΛₘ′=0.1 nm if M=5. An electronic masker or laser should therefore be able to resolve a certain number of values within the domain ΔΛ′=0.1 nm in order to obtain a period Λ′(x′) gradually decreasing from the centre towards the edges of the field. If such a requirement can be satisfied technically by deflection of the electronic beam or writing laser, it is not yet available in the normal maskers in which the addressing grid is fixed and has a step p as small as 0.1 nm for the LION LV1 by Leica with the teaching of the patent DE 10011202.1, or which is of the order of 1 nanometre in the laser maskers.

A predistortion is however already possible with existing maskers when the continuous writing mode is not available: instead of writing the lines of the corrected grating with a continuous variation of the period, the lines will be written by groups of lines attached to the addressing grid by rounding of the longitudinal position of the grating lines of the mask. Supposing that the nominal period Λ₀ corresponds exactly to the addressing grid, the line of the order number m of the grating of the corrected mask must be located at a distance xₘ′ from x₀′

xₘ′=mΛ₀′−4ΔΛₘ′Λ₀′²(1+4+9+ . . . +m²)/C′²

The order number m of the grating line, the position xₘ′ of which corresponds to a whole number i of grid increments p relative to its position mΛ₀′ in a strictly periodic grating is given by

4ΔΛₘ′Λ₀′²/C′²(m(2m²+3m+1)/6)=−ip which can be written

m³+3m²/2+m/2+Tᵢ=0 où Tᵢ=3ipC′²/(4ΔΛₘ′Λ₀′²)

Let m=n−1/2 The equation becomes:

n³−n/4+Tᵢ=0 the solution of which is known and leads to

m=PE(0.289(1+tg²α)/tgα−½) where tgα=(Tᵢ/0.048(1−(1−(0.048/Tᵢ)²)^{1/2}))^{1/3}

In the case of a grating produced by a “step and repeat” camera with M=5, C=16 mm, ΔΛₘ=2 10⁻⁵ μm, Λ₀=1 μm and one step of the writing grid of the mask p=1 nm, Tᵢ=1.92 10⁹ i where i is the order number of the increment p. Tᵢ is thus very large with the result that m is substantially equal to Tᵢ^{1/3}.

In the example given above of a corrected grating mask, there will be written on both sides of the centre of the field 1243 periods Λ₀′ of 5,000 μm after which the totality of the periods Λ₀′ up to the order number 1566 will be written with a shift of p=1 nm towards the centre of the field, and so on, to each number of the order i of the period m=PE(Tᵢ^{1/3}) the periods of the following entirety of the periods Λ₀′ are shifted by p towards the centre up to m=266 for the present case, which corresponds substantially to the ends of the field of length 5×16 mm.

In this example, the spatial coherence of a field of the grating is not perfectly corrected but it is sufficiently so for a plurality of applications, in particular for the production of measuring gratings for displacement sensors.

This example of predistortion by increments is not limiting. In fact, the production method according to the invention is applied likewise to a new generation of maskers in the course of development which will allow a predistortion in smaller increments, and even continuous. For example, a spatial frequency distribution having a predetermined monotonic increase or decrease, as in a phase grating for producing compensators for dispersion by a Bragg grating in a fibre optic, can be inscribed on a predistorted mask in a similar fashion. Furthermore, the errors and aberrations of a type other than the one given by the expressions (10) and (12) can be corrected in a similar fashion. The person skilled in the art will be able to choose the masker and the method of writing the mask which are the most appropriate for defining the corrected mask closest to the one which is specified.

It will be noted that the device according to the invention and the production process described here applies likewise to bidirectional gratings (crossed grating) or the device of the invention is used in order to characterise the spatial coherence according to the orthogonal axes X and Y of such a grating.

A second method of producing optical gratings continuously according to the invention is illustrated schematically in FIG. 6. A device according to the invention 2 is provided downstream of a system for writing or forming a grating 14. The phasemeter 24 provides a control signal 50, i.e. the signal Ψ(x) defined previously or a function of the latter, to an interface 52 associated with the writing means 48. The interface 52 provides for example a control signal of a frequency Ω serving to modulate the amplitude of two interfering beams in order to define the lines of the grating in formation in a photosensitive film provided on the substrate 30. The device 2 according to the invention allowing very precise measurement of a variation of the number of periods or lines of the grating 14 in formation over the distance L, the control signal 50 is used to define very precisely this modulation frequency Ω and to vary the latter so as to obtain in particular a grating which has a constant period. According to another mode of implementation, it is likewise possible to act on the introduction means and to provide the control signal 50 to means for controlling the displacement speed of the substrate 30, whilst preserving the constant modulation frequency. A similar system for producing gratings can be provided with writing means 48 providing UV beams in order to polymerise a polymer layer provided on the surface of the substrate 30.

A similar system can likewise be used in the case of forming a grating by cold pressing by means of a cylinder which has on its rolling surface a machined grating to be transferred onto the substrate 30. In order to obtain a constant period corresponding to that defined by the writing cylinder, it is necessary that the speeds of rotation of the cylinder and the running speed of the substrate 30 in the forming region of the grating are identical. The device 2 therefore provides a control signal either for the speed of rotation of the cylinder or for the running speed of the substrate 30.

A similar system can likewise be used in other installations for forming continuous gratings using other techniques known to the person skilled in the art, in particular by means of laser beams or electronic beams or even ionic beams.

It will be noted that in the case where the control signal serves to control writing means with the aim of ensuring for example a constant spatial frequency, an increase in the number of periods detected over the length L by the device 2 at a substantially constant speed will lead to reducing the writing frequency whilst a reduction in the number of periods will lead to increasing this frequency. The device 2 for linear control hence allows the establishment of a retroactive control loop in order to control the writing of the grating continuously. In the case where the device 2 provides a control signal to means for controlling the displacement of the substrate 30, the detection of an increase in the number of periods over the distance L by this device will result in an increase in the displacement speed of this substrate 30, whilst a decrease in this number of periods will result in a decrease in the displacement speed.

Starting from the reasonable hypothesis that the variations of the spatial frequency of the grating 14 in formation are substantially continuous with a slight gradient relative to the temporal variable, a simple calculation shows that this second method allows control of the spatial period of the produced grating with a precision greater than one hundredth of a nanometre.

By means of FIG. 7, there will be described hereafter a first optical device for determining the spatial frequency of a diffraction grating according to the invention.

FIG. 7 is a schematic view from above. The device 54 comprises a first sensor 4 and a second sensor 6 similar to those described by means of FIG. 1. These two sensors are likewise connected to a phasemeter (24) as for the device of FIG. 1. Hence, the device 54 differs from that of FIG. 1 essentially by the fact that the sensors 4 and 6 are shifted relative to a direction parallel to the lines of the gratings. In the preferred embodiment of FIG. 7, the sensors 4 and 6 are located one beside the other relative to a displacement direction x, i.e. the distance L is zero. The sensors 4 and 6 are provided such that they are respectively located opposite a grating 34, for which it is intended to determine the absolute period, and opposite a reference grating 56 having a defined spatial frequency, preferably a constant and precisely defined period Λ₀. It will be noted here that the precise determination of the period Λ₀ of the grating 54 can be determined by means of a second device represented in FIG. 8 which will be described subsequently.

The device 54 allows measurement of the absolute value Λ of the spatial frequency of the grating 34 as long as this period is substantially constant, i.e. it only varies slightly around a mean value to be determined, this being essentially for reasons of interference contrast sufficient to detect AC signals for the sensors 4 and 6. If the Λ deviates from Λ₀ by less than 0.1% approximately, the reading gratings of the sensors 4 and 6 can have the same period Λ₀/2. In contrast, if Λ deviates from Λ₀ by more than 0.1% approximately, it is necessary to provide two reading gratings with periods which are different and substantially equal to half of Λ and of Λ₀. Thus it is necessary to know approximately the value of Λ in order to be able to determine it then very precisely by means of the device 54. For example, for grating periods of the micron order, it is necessary to know in advance the value of Λ at best within 1 nm, which is generally the case.

By displacing the device 54 located at x by a distance Δx, the value of Λ(x) is given by the following analytical formula:

Λ(x)=Λ₀/[(1Ψ(Δx)/Δφᵣ(Δx)] (13)

where Ψ(Δx) is the difference of the phases measured by the two sensors 4 and 6 during the displacement Δx and Δφᵣ(Δx) is the accumulated phase measured by the reference sensor 6 provided above the reference grating 56 during the displacement Δx.

It will be noted that it is not necessary to determine Δx, but the measuring precision increases with the increase in Δx; however an absolute value of the period Λ(x) is obtained which is an average defined over a greater domain Λx. The device 54 allows measurement in a very precise manner, i.e. with a precision better than one hundredth of a nanometre, the period Λ(x) of the grating 34 when this period has substantially continuous and slow variations.

The principle for measuring the absolute period by the device 54 is based therefore essentially on the fact that the first and second sensors 4 and 6 provide respectively first and second electrical signals which are respectively a function of the spatial frequency of the grating to be measured 34 and of the spatial frequency of the reference grating 56 during a relative displacement along x. Furthermore, the fact that the sensors 4 and 6 are integral with each other and are subjected to the same displacement along the gratings allows very precise determination of an accumulated phase difference during a displacement Δx.

By means of FIG. 8, there will be described hereafter a second optical device for determining the absolute spatial frequency of a diffraction grating 56.

The device 60 differs essentially from that described by means of FIG. 1 in that there is provided a third interferometric diffractive sensor located at a distance L₂ from the first sensor 4 whilst the latter is located at a distance L₁ from the second sensor 6. The third sensor 62 is preferably located beside the sensor 6, the sensors 6 and 62 being provided so that they are both located opposite the grating 56 during a displacement along the latter. The distances L₁ and L₂, which are defined between centres of the reading gratings, are close but different. In FIG. 8, the sensors have been represented schematically only by their reading grating. In any case, the third sensor 62 is similar to the sensors 4 and 6 and likewise comprises at least one light intensity detector as well as its reading grating 64.

The sensor 62 likewise provides an electrical signal which is a function of the spatial frequency of the diffraction grating 56 in a useful region of the latter located opposite the reading grating 64. The device 60 likewise comprises means for measuring a difference between the phases of the electrical signals provided respectively by the sensors 4 and 62 and means for measuring an accumulation of this difference or means for measuring the accumulation of each of the two phases and means for then measuring their difference. The device 60 is associated with or comprises furthermore means for analysing first and second differences measured between the sensor 4 and respectively the second and third sensors 6 and 62. These analysis means are provided in order to provide a signal corresponding to the value of the spatial frequency or of the period of the grating 56.

Generally, the device 60 comprises two pairs of detectors separated by determined distances. Preferably, in the embodiment described here, a sensor of each of these pairs is formed by one and the same sensor 4. As already mentioned previously, when the period Λ of the grating to be measured deviates by more than twice the period of the reading gratings which is identical for the three sensors, fringes form on the detectors which measure nothing but a DC signal which gives no useful information. According to the embodiment described by the document EP 0 741 282, and in the case where the space between the reading gratings and the grating 14 of FIGS. 1 or 30 of FIGS. 6 or 34 and 56 of FIGS. 7 and 8 is very small, for example between 50 and 150 μm, and where the reading gratings of length L′ in the direction perpendicular to the grating lines are completely and substantially uniformly illuminated by collimated incident beams originating from light sources, the deviation dΛ around Λ₀ for which the interference contrast is cancelled is substantially dΛ=+−Λ₀²/(2L′) where Λ₀ is twice the period of the reading gratings. It is seen in particular that the domain 2dΛ around Λ₀ in which the amplitude of the AC electrical signals is measurable can be enlarged by using shorter reading gratings.

For a reading grating length L′ of 1 nm and a period Λ₀=1 μm for maximum contrast, the period Λ of the grating 56 must be different from Λ₀ by at least dΛ=0.5 nm in order to obtain a measurable AC signal.

A being therefore determined within a width domain Λ₀²/L′ around Λ₀, the device 60 allows more precise determination of the value of Λ by means of at least two measurements Ψ₁(Δx) and Ψ₂(Δx) between the two pairs of sensors.

With L₂<L₁ and N₀₁ and N₀₂ the whole or non-whole numbers of periods Λ₀ contained respectively in L₁ and L₂, the maximum difference between these two lengths can be determined mathematically in order to allow an unambiguous determination of Λ. dΛ being the maximum difference of Λ relative to Λ₀ allowing the detection of a non-zero AC signal by the sensors 4, 6 and 62 and N₁, N₂ being the whole or non-whole numbers of periods Λ contained respectively in L₁ and L₂, the non-ambiguous determination condition of Λ in the domain dΛ is written:

[(N₀₁−N₁)−(N₀₂−N₂)]·4π<π (14)

which gives

L₁−L₂<Λ₀²/4dΛ (15)

Thus, for example if Λ₀=1 μm, dΛ=0.5 nm, L₁−L₂ must be less than 500 μm.

As mentioned previously, the resolution in the determination of the absolute value of Λ can be obtained at better than a hundredth of a nanometre.

The absolute determination of an unknown period Λ=Λ₀+ΔΛ can be effected according to the following preferred embodiment. The electrical phase Ψ₁(Λ) and Ψ₂(Λ), corresponding to the whole or non-whole number N₁ and N₂ of unknown periods Λ over the distances L₁ and L₂ between reading grating centres, is given by Ψ₁(Λ)=4πN₁ and Ψ₂(Λ)=4πN₂ L₁ and L₂ are chosen so as to contain exactly a semi-whole number v₀₁/2 and v₀₂/2 of periods Λ₀, v₀₁ and v₀₂ being whole numbers. This is possible because the reading gratings are written on the same substrate by means of an electronic masker controlled by interferometry such as a LION LV1 by Leica.

The electrical phase difference ΔΨ₁=Ψ₁(Λ₀)−Ψ₁(Λ) between the phase for the period Λ₀ and the phase for the period Λ over L₁ is

ΔΨ₁(Λ)=4π(L₁/Λ−v₀₁/2)

and

ΔΨ₂(Λ)=4π(L₂/Λ−v₀₂/2)

Now, the first and second sensors measure ΔΨ₁ and ΔΨ₂ modulo 2π, i.e. ΔΨ₁ₘ and ΔΨ₂ₘ with

ΔΨ₁ₘ=4πL₁/Λ−2πPE(2L₁/Λ)

ΔΨ₂ₘ=4πL₂/Λ−2πPE(2L₂/Λ)

with PE(x) defining the whole part of x.

Now, by the condition L₁−L₂<Λ₀²/(4d Λ), it is known that ΔΨ₁ₘ−ΔΨ₂ₘ is defined without ambiguity within the phase domain (−π, +π) as long as ΔΛ<dΛ. Therefore

ΔΨ₁ₘ−ΔΨ₂ₘ=4π(L₁₋L₂)/Λ=4π(L₁−L_{2)/Λ}₀−4πΔΛ(L₁−L₂)/Λ₀²

Because the term 4π(L₁−L₂)/Λ₀ is a whole number times 2π,

ΔΛ=−Λ₀²(ΔΨ₁ₘ−ΔΨ₂ₘ)/(4π(L₁−L₂))

where ΔΨ₁ₘ−ΔΨ₂ₘ are the phases effectively measured by the two sensors.

Therefore Λ=Λ₀+ΔΛ is determined.

The resolution with which the period A can be determined in the domain 2dΛ depends upon the resolution E given over the phase of the electrical signals by the phasemeter and is essentially εdΛ/π.

1. Optical device (2) for characterising a diffraction grating (14, 34), characterised in that it is formed by first and second interferometric diffractive sensors (4, 6) which are integral, spaced apart from each other at a determined first distance (L; L1), and each comprise at least one reading grating (10a, 10b) and at least one light intensity detector (11a, 12a, 11b, 12b), these first and second sensors providing respectively first and second electrical signals which, during a relative displacement (Δx) between the device and said diffraction grating, vary as a function of the spatial frequency of this diffraction grating in first and second regions of the latter, which regions are located respectively opposite two reading gratings and each receive light supplied by at least one light source.

2. Optical device (54) for determining the spatial frequency of a diffraction grating (34), characterised in that this device is associated with a reference grating (56) and in that it comprises first and second interferometric diffractive sensors (4, 6) which are integral and comprise respectively first and second reading gratings which are shifted relative to a direction parallel to their lines so that they are able to be located respectively opposite said diffraction grating and said reference grating, these first and second sensors providing respectively first and second electrical signals which, during a relative displacement between the device and said diffraction grating, are respectively a function of the spatial frequency of said diffraction grating and of the spatial frequency of said reference grating.

3. Optical device according to claim 1 or 2, characterised in that said first and second signals define first and second phases of first and second interferometric diffractive sensors respectively in said first and second regions.

4. Optical device according to claim 3, characterised in that it comprises furthermore either means (24) for measuring a first difference between the respective phases of the first and second electrical signals and means for measuring the accumulation of this first difference during a displacement of the device relative to said diffraction grating according to a direction which is not parallel to its lines, or means for measuring the two accumulations of respective phases of said first and second electrical signals and means (24) for measuring the first difference of these two accumulations as a function of said displacement.

5. Optical device according to claim 4, characterised in that it comprises furthermore means for memorising said first difference and/or a function of the latter as a function of said relative displacement.

6. Optical device according to claim 4 or 5, characterised in that it comprises or is associated with means for analysing and/or processing said first difference as a function of a relative position between this device and said diffraction grating or as a function of said relative displacement so as to determine the spatial frequency of the diffraction grating or so as to provide at least one item of information relating to a variation of this spatial frequency.

7. Optical device (60) for determining the spatial frequency of a diffraction grating according to one of the claims 4 to 6 with claim 3 depending directly upon claim 1, characterised in that there is provided a third interferometric diffractive sensor (62) located respectively at a second distance (L2) determined by said first sensor (4), said first and second determined distances being close but different, said third sensor likewise comprising a reading grating (64) and at least one light intensity detector, this third sensor providing, during a relative displacement between the device and said diffraction grating (56), a third electrical signal which is a function of the spatial frequency of said diffraction grating in a third region of the latter located opposite the reading grating of this third sensor, this device likewise comprising means for measuring a second difference between the phases of said first and third electrical signals, means for measuring an accumulation of this second difference, and means for analysing said first and second differences which are provided in order to provide a signal corresponding to the value of the spatial frequency or of the period of said diffraction grating.

8. Optical device according to claim 7, characterised in that said third signal defines a third phase of said diffraction grating in said third region.

9. Method of producing optical gratings by means of a photolithographic process, in which a mask, defining an object grating or a field of the latter, is projected onto a substrate via an optical system having aberrations, characterised in that the following successive steps are provided:
a preliminary step in which a first mask, defining a grating with a precisely determined spatial frequency, is projected onto a test substrate;
a step for characterising a first test grating formed on said test substrate during the preliminary step by means of an optical device according to one of the claims 1 to 6 with claim 3 depending directly upon claim 1;
the production of a second predistorted mask as a function of the characterisation of said first test grating so as to compensate for said aberrations;
the production of said optical gratings on one or more substrate(s) with the use of said second predistorted mask so that these optical gratings have a precisely predefined spatial frequency distribution.

10. Method of producing an optical grating on a substrate, in particular a grating band like a fibre optic, by means of continuous writing means of this grating, the latter being subjected to a controlled displacement relative to writing means, characterised in that it is intended to provide downstream of said writing means an optical device according to one of the claims 1 to 6 with claim 3 depending directly upon claim 1, and in that this optical device is provided in order to provide a control signal to said writing means or to means for controlling said displacement, this control signal being a function of said first and second electrical signals.
